(19) United States
(12) Patent Application Publication
(10) Pub. No.: US 2020/0160075 A1
(43) Pub. Date: May 21, 2020

(54) VEHICLE LOST OBJECT PREVENTION

(71) Applicant: Ford Global Technologies, LLC, Dearborn, MI (US)

(72) Inventors: James Hadley MUITER, Plymouth, MI (US); Christopher Jacob LOCKWOOD, Ann Arbor, MI (US); Robert R. HOVELAND, Plymouth, MI (US); Balbir GREWAL, Ann Arbor, MI (US); Sara PIERCE, Ferndale, MI (US); Jacob Park BRAYKOVICH, Detroit, MI (US); Moussa Khalil BAZZI, Dearborn, MI (US); John MUSCAT, Canton, MI (US)

(21) Appl. No.: 16/611,038

(22) PCT Filed: May 5, 2017
(86) PCT No.: PCT/US17/31261

§ 371 Date: Nov. 5, 2019

(51) Int. Cl. G06K 9/00; B60R 11/04; B60Q 3/80; G08B 21/24

(52) U.S. Cl. CPC G06K 9/00832; B60R 11/04; B60Q 3/80; B60R 2011/0003; G06K 9/00201; B60R 2300/8006; G08B 21/24

(57) ABSTRACT

A vehicle system includes a memory and a processor programmed to execute instructions stored in the memory. The instructions include receiving an object detection signal and an egress signal, determining that the object detection signal represents an object in a host vehicle, determining that the egress signal represents a passenger attempting to exit the host vehicle, and activating an 0 interior light in accordance with the object detection signal and the egress signal.

### BACKGROUND

Vehicle passengers often carry items with them. Vehicles have several storage compartments for the passenger's convenience. The storage compartments include cup holders, the glove box, open storage trays, a center console, etc.

### BRIEF DESCRIPTION OF THE DRAWINGS

FIG. 1 illustrates an example host vehicle with an object detection system that detects a potentially forgotten object before a passenger has exited the host vehicle.

FIG. 2 is a block diagram illustrating example components of the object detection system.

FIGS. 3A and 3B illustrate example interior views of the host vehicle with the object detection system.

FIGS. 4A and 4B illustrate an example vehicle light that illuminates an area inside the host vehicle to help the passenger find the potentially forgotten object.

FIG. 5 is a flowchart of an example process that may be executed by the object detection system to detect the potentially forgotten object in the host vehicle before the passenger has exited the host vehicle.

### DETAILED DESCRIPTION

Passengers often leave items behind in vehicles. While not usually an issue when a passenger leaves an item in his or her own car, leaving behind an item in a ride-sharing vehicle, a ride-hailing vehicle, or a taxi can be inconvenient. The problem is compounded with autonomous vehicles since there is no driver to confirm that a previous passenger took all of his or her belongings when the passenger exited the vehicle. Moreover, in an autonomous taxi scenario, a subsequent passenger may complain if the autonomous vehicle is littered with items belonging to a previous passenger.

One possible solution includes a host vehicle equipped with an object detection system that detects that an object was left behind before the passenger exits the vehicle and helps the passenger find the object.

In one possible approach, the object detection system includes a memory and a processor programmed to execute instructions stored in the memory. The instructions include receiving an object detection signal and an egress signal, determining that the object detection signal represents an object in a host vehicle, determining that the egress signal represents a passenger attempting to exit the host vehicle, and activating an interior light in accordance with the object detection signal and the egress signal.

The processor may be programmed to activate the interior light by outputting an illumination signal to the interior light. In some instances, the interior light is one of a plurality of interior lights and the processor is programmed to select at least one of the plurality of interior lights to activate. The processor is programmed to select among the plurality of interior lights by querying a look-up table stored in the memory. The query identifies an object sensor that output the object detection signal. Alternatively or in addition, the query identifies a location of an object sensor that output the object detection signal. The processor may be programmed to control a status light according to the object detection signal and the egress signal. The processor may be programmed to monitor an output of an object sensor to determine whether the object detection signal represents the object in the host vehicle. The processor may be programmed to monitor an output of an egress sensor to determine whether the egress signal indicates that the passenger is attempting to exit the host vehicle. The processor may be programmed to command the interior light to shine on the object in accordance with the object detection signal and the egress signal. The processor may be programmed to command the interior light to shine on an area near the object in accordance with the object detection signal and the egress signal.

An example method includes receiving an object detection signal, receiving an egress signal, determining that the object detection signal represents an object in a host vehicle, determining that the egress signal represents a passenger attempting to exit the host vehicle, and activating an interior light in accordance with the object detection signal and the egress signal.

Activating the interior light may include outputting an illumination signal to the interior light. In instances where the interior light is one of a plurality of interior lights, the method may further include selecting at least one of the plurality of interior lights to activate. Selecting among the plurality of interior lights may include querying a look-up table stored in a memory. The query may identify an object sensor that output the object detection signal. Alternatively or in addition, the query may identify a location of an object sensor that output the object detection signal.

The method may further include controlling a status light according to the object detection signal and the egress signal. In some instances, the method includes monitoring an output of an object sensor to determine whether the object detection signal represents the object in the host vehicle. In some possible implementations, the method includes monitoring an output of an egress sensor to determine whether the egress signal indicates that the passenger is attempting to exit the host vehicle.

The method may further include commanding the interior light to shine on the object in accordance with the object detection signal and the egress signal. Alternatively or in addition, the method may include commanding the interior light to shine on an area near the object in accordance with the object detection signal and the egress signal.

The elements shown may take many different forms and include multiple and/or alternate components and facilities. The example components illustrated are not intended to be limiting. Indeed, additional or alternative components and/or implementations may be used. Further, the elements shown are not necessarily drawn to scale unless explicitly stated as such.

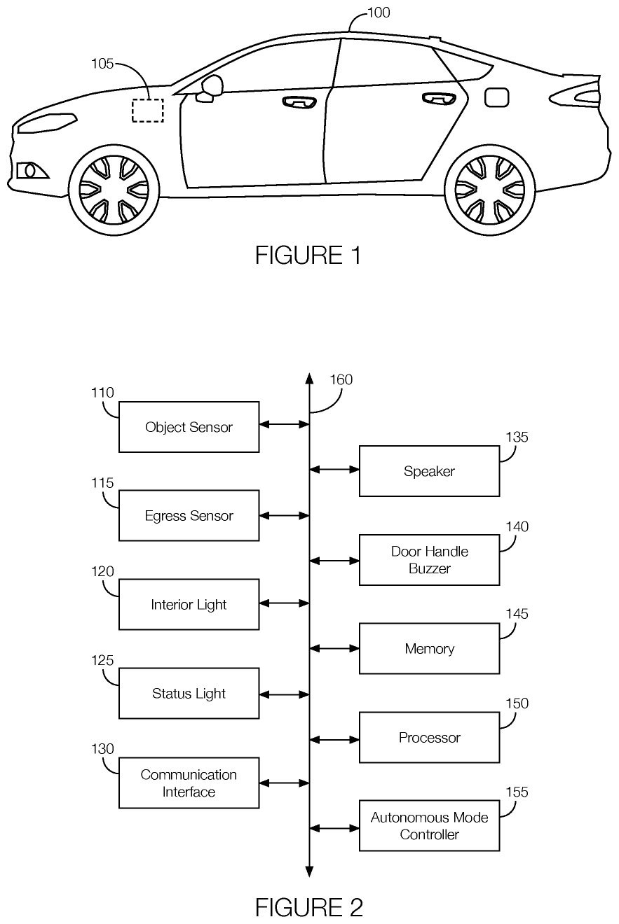

As illustrated in FIG. 1, a host vehicle 100 includes an object detection system 105 that detects an object left in the host vehicle 100, detects when a passenger is attempting to exit the host vehicle 100, alerts the passenger that an object remains in the host vehicle 100, and helps the passenger find the object before the passenger exits the host vehicle 100.

Although illustrated as a sedan, the host vehicle 100 may include any passenger or commercial automobile such as a car, a truck, a sport utility vehicle, a crossover vehicle, a van, a minivan, a taxi, a bus, etc. In some instances, the host vehicle 100 is an autonomous vehicle that can operate in an autonomous (e.g., driverless) mode, a partially autonomous mode, and/or a non-autonomous mode. The Society of Automotive Engineers (SAE) has defined multiple levels of autonomous vehicle operation. At levels 0-2, a human driver monitors or controls the majority of the driving tasks, often with no help from the vehicle. For example, at level 0 (“no automation”), a human driver is responsible for all vehicle operations. At level 1 (“driver assistance”), the vehicle sometimes assists with steering, acceleration, or braking, but the driver is still responsible for the vast majority of the vehicle control. At level 2 (“partial automation”), the vehicle can control steering, acceleration, and braking under certain circumstances without human interaction. At levels 3-5, the vehicle assumes more driving-related tasks. At level 3 (“conditional automation”), the vehicle can handle steering, acceleration, and braking under certain circumstances, as well as monitoring of the driving environment. Level 3 requires the driver to intervene occasionally, however. At level 4 (“high automation”), the vehicle can handle the same tasks as at level 3 but without relying on the driver to intervene in certain driving modes. At level 5 (“full automation”), the vehicle can handle almost all tasks without any driver intervention.

FIG. 2 is a block diagram illustrating example components of the object detection system 105 or example components of the host vehicle 100 that may interact with the object detection system 105. The components illustrated in FIG. 2 include an object sensor 110, an egress sensor 115, an interior light 120, a status light 125, a communication interface 130, a speaker 135, a door handle buzzer 140, a memory 145, a processor 150, and an autonomous mode controller 155. Some or all of these components may communicate with one another over a communication link 160. The communication link 160 includes hardware, such as a communication bus, for facilitating communication among these and possibly other components of the object detection system 105, host vehicle 100, or both. The communication link 160 may facilitate wired or wireless communication among the vehicle components in accordance with a number of communication protocols such as controller area network (CAN), Ethernet, WiFi, Local Interconnect Network (LIN), and/or other wired or wireless mechanisms.

The object sensor 110 is implemented via circuits, chips, or other electronic components that can detect objects left behind in the host vehicle 100. The object sensor 110 may be a light scanner with one or more transmitters that transmit light across a portion of the interior of the host vehicle 100. The light is transmitted to one or more receivers spaced from each transmitter. The space between the transmitter and receiver may be empty when no objects are left behind in the host vehicle 100. When an object is left behind, the object may prevent light from reaching the receiver. In that case, the object sensor 110 may output an object detection signal indicating that an object has been left behind, the location in the vehicle where the object was detected, etc. Another type of object sensor 110 may be a proximity sensor that detects an object, based on proximity, where no object should be. The proximity sensor may output the object detection signal upon detection of an object. The object sensor 110 may be further or alternatively implemented as a camera or other type of vision sensor. The camera may capture images of one or more locations in the host vehicle 100. To capture such images, the camera may include a lens that projects light toward, e.g., a CCD image sensor, a CMOS image sensor, etc. The camera processes the light and generates the image. The image may be processed by the camera or output to the processor 150 for processing. Processing the image may include comparing the image to an image of a portion of the interior of the host vehicle 100 with no objects left behind or with known objects located in the host vehicle 100. That way, passengers will not be asked to remove objects that were already in the host vehicle 100 at the time the passenger entered the host vehicle 100. Differences in the images may indicate that an object has been left behind, the location of the object, etc. The camera may output the object detection signal when the captured image reveals an object left behind in the passenger compartment. The object sensor 110 may be implemented as any one or more of these types of sensors. For instance, the light scanner, the camera, or both may be used to detect objects left on the floor, the seats, the dashboard, etc. The proximity sensor may be used to detect objects left in the glove compartment, cup holder, door storage area, etc.

The egress sensor 115 is implemented via circuits, chips, or other electronic components that detects when a passenger is attempting to exit the host vehicle 100. The egress sensor 115 may be implemented via a proximity sensor, located on or near an interior door handle, that detects when the passenger reaches for or grabs the door handle from inside the host vehicle 100. Another type of egress sensor 115 may include a sensor that detects when one of the vehicle doors is opened. The egress sensor 115 may be programmed or configured to output an egress signal when it detects that the passenger is attempting to exit the host vehicle 100. The egress signal may be output, by the egress sensor 115, to the processor 150.

The interior light 120 is implemented via one or more light emitting diodes or other light source, such as a light bulb, an accent light, etc. that illuminates part of the interior of the host vehicle 100. The interior light 120 may illuminate in response to an illumination signal output by the processor 150. In some instances, each interior light 120 may be associated with a particular area of the interior of the host vehicle 100. For instance, different interior lights 120 may be associated with the cup holder, glove box, vehicle floor, vehicle seats, etc. Thus, depending on where an object is left behind, the interior light 120 associated with that location may be illuminated via the illumination signal. In some possible implementations, the light source may be directed to shine directly on the object, or an area near the object, left in the host vehicle 100. For instance, if the interior light 120 is implemented via a vehicle dome light, the interior light 120 may shine directly onto the cup holder if it is determined that an object was left behind in the cup holder.

The status light 125 is implemented via one or more light emitting diodes or other light source located, e.g., in the vehicle door or another location where the status light 125 can be viewed by the passenger when the passenger is attempting to exit the host vehicle 100. The status light 125 may be configured or programmed to illuminate different colors. Each color may correspond to a different status of an object left behind in the host vehicle 100. For example, the status light 125 may shine green when no objects have been left behind in the host vehicle 100 and the passenger is free to exit the host vehicle 100. The status light 125 may shine yellow when an object is detected in the host vehicle 100 but the passenger is permitted to open the vehicle door despite the potentially left-behind object. The status light 125 may shine red if the doors are locked and the passenger is prevented from opening the vehicle door because, e.g., exiting the host vehicle 100 will mean that an object will be left behind.

The communication interface 130 is implemented via an antenna, circuits, chips, or other electronic components that facilitate wireless communication between the host vehicle 100 and a mobile device belonging to a passenger of the host vehicle 100. The communication interface 130 may be programmed to communicate in accordance with any number of wired or wireless communication protocols. For instance, the communication interface 130 may be programmed to communicate in accordance with a satellite-communication protocol, a cellular-based communication protocol (LTE, 3G, etc.), Bluetooth®, Bluetooth® Low Energy, Ethernet, the Controller Area Network (CAN) protocol, WiFi, the Local Interconnect Network (LIN) protocol, etc. In some instances, the communication interface 130 is incorporated into a vehicle telematics unit. The communication interface 130 may be programmed to pair with the passenger's mobile device after, e.g., the passenger enters the host vehicle 100. The communication interface 130 may further communicate with the mobile device via, e.g., an app that allows the passenger to request the host vehicle 100 in an autonomous pick-up or ride sharing situation.

The speaker 135 is implemented via an electroacoustic transducer that converts electrical signals into sound. Specifically, the transducer vibrates in accordance with the electrical signals received. The vibrations form sounds. The speaker 135 may be used to provide alerts to passengers of the host vehicle 100. For example, the speaker 135 may receive a control signal output by the processor 150, and the control signal may cause the speaker 135 to present an audible alert to the passenger. The audible alert may indicate that an object has been or is about to be left behind in the host vehicle 100.

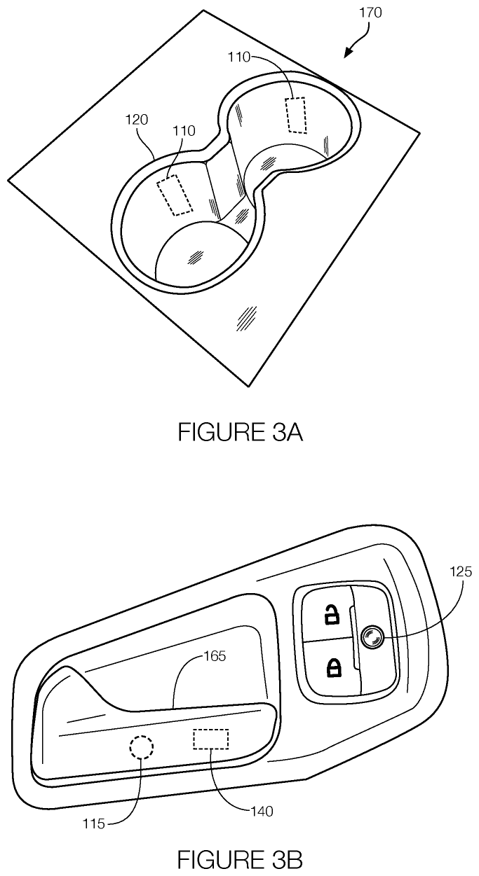

The door handle 165 (see FIG. 3B) includes a lever that can be actuated by the passenger. Actuating the lever allows the door to open. In some instances, the door handle buzzer 140 is a piezoelectric buzzer or another electromechanical device is located in the door handle. When activated, the buzzer 140 vibrates the door handle, which may provide haptic feedback to the passenger that an object is about to be left behind in the host vehicle 100. The buzzer 140 may vibrate in accordance with a control signal received from the processor 150.

The memory 145 is implemented via circuits, chips or other electronic components and can include one or more of read only memory (ROM), random access memory (RAM), flash memory, electrically programmable memory (EPROM), electrically programmable and erasable memory (EEPROM), embedded MultiMediaCard (eMMC), a hard drive, or any volatile or non-volatile media etc. The memory 145 may store instructions executable by the processor 150 and data such as a table relating the colors of the status light 125 to different outputs of the object detection sensor, the egress sensor 115, or both. The instructions and data stored in the memory 145 may be accessible to the processor 150 and possibly other components of the object detection system 105, the host vehicle 100, or both.

The processor 150 is implemented via circuits, chips, or other electronic component and may include one or more microcontrollers, one or more field programmable gate arrays (FPGAs), one or more application specific circuits ASICs), one or more digital signal processors (DSPs), one or more customer integrated circuits, etc. The processor 150 can receive the data from the object sensor 110 and egress sensor 115 and activate the interior light 120 as a result of receiving both the egress signal and the object detection signal. That is, the processor 150 may programmed to determine that receipt of the object detection signal means that an object belonging to the passenger was set down in the host vehicle 100. The processor 150 may be further programmed to determine where the object is located based on the object sensor 110 that detected the object. The processor 150 may be programmed to determine that receipt of the egress signal means that the passenger is attempting to exit the host vehicle 100. In other instances, the processor 150 may be programmed to process the object signal, the egress signal, or both, to determine whether an object is present, the passenger is attempting to exit the host vehicle 100, or both. In either implementation, the processor 150 is programmed to determine that receipt of both the egress signal and the object signal means that the passenger is attempting to exit the host vehicle 100 while an object remains set down in the host vehicle 100, which makes it more likely that the object will be left behind should the passenger be permitted to exit the host vehicle 100.

In instances where the object sensor 110 is a camera, the processor 150 may be programmed to perform image processing on images captured by the camera. That is, the processor 150 may compare images captured by the camera to those representing a host vehicle 100 with no objects left behind. The processor 150 may be programmed to determine that detection of objects in the most recent images captured by the object sensor 110 means that an object has been left behind or is about to be left behind should the passenger exit the host vehicle 100.

Simply receiving the egress signal and the object detection signal may not be enough for the processor 150 to conclude that an object is about to be left behind in the host vehicle 100. For instance, the processor 150 may be programmed to determine that the object is about to be left behind in the host vehicle 100 if the egress signal is received while the object sensor 110 is presently outputting the object detection signal (e.g., the output of the object sensor 110 is “high”) or while the processor 150 determines that the object detection signal otherwise indicates that an object was set down in the host vehicle 100. It is possible that the output of the object sensor 110 may go “low” (which could include the processor 150 determining that the object is no longer set down in the host vehicle 100) before the passenger attempts to exit the host vehicle 100. In that case, the processor 150 may do nothing since the output of the object sensor 110 being low suggests that the object was picked up by the passenger. Thus, upon receipt of the egress signal, the processor 150 may be programmed to confirm whether the object has been removed by, e.g., checking if the output of the object sensor 110 is still high before illuminating the interior light 120 or generating other types of alerts.

The processor 150 is programmed to output various control signals under various circumstances. For instance, after receiving the egress signal and while the object detection signal is high, the processor 150 may be programmed to activate the interior light 120. The processor 150 may be programmed to activate the interior light 120 by outputting the illumination signal to the interior light 120. The illumination signal may cause the interior light 120 to flash, change colors, etc., so that it is more likely to get the attention of the passenger. The processor 150 may, in some instances, select between or among multiple interior lights 120. The processor 150 be programmed to may determine where in the host vehicle 100 is object was set down based on the object sensor 110 that output the object detection signal. The processor 150 may be programmed to determine which interior light 120 to activate by querying the look-up table stored in the memory 145. The query may include the object sensor 110 that output the object detection signal, the location of the object sensor 110, or both.

The processor 150 may be further programmed to control the status light 125 according to whether the egress signal, the object detection signal, or both, have been received. The processor 150 may be programmed to determine which status the status light 125 should present by querying the look-up table stored in the memory 145. For instance, the processor 150 may program the look-up table based on whether an object has been detected, where the object is located, whether the passenger is permitted to exit the host vehicle 100 while an object is detected, etc. The result of the query may allow the processor 150 to determine which control signal to output to the status light 125. That is, continuing with the color-coded example above, the result of the query may allow the processor 150 to determine whether the status light 125 should shine red, yellow, or green.

Another control signal output by the processor 150 may include a control signal that can be output to door lock actuators that, e.g., lock and unlock the vehicle doors. The processor 150 may output a control signal to the door lock actuators to, e.g., lock the vehicle doors when the object detection signal is high and the egress signal is received. Alternatively, the processor 150 may output the control signal to a controller, such as a body control module, which may in turn control the door lock actuators according to the control signal output by the processor 150. By controlling the door locks, the processor 150 may prevent the passenger from exiting the host vehicle 100 while an object remains in one of the storage compartments, on the seat, on the floor, or somewhere else where it may be left behind if the passenger is permitted to exit the host vehicle 100. The processor 150 may be programmed to output a control signal to the door lock actuators or body control module if, e.g., the object is removed from the storage compartment, seat, floor, etc.

Rather than completely lock the passenger in the host vehicle 100, the processor 150 may be programmed to delay unlocking the vehicle doors. This delay may be implemented by a timer circuit incorporated into or separate from the processor 150. The delay may be on the order of a few seconds and may accompany an audible alert presented through the speakers 135 asking that the passenger retrieve any objects left in any storage compartments, on a vehicle seat, on the floor, etc. If an object is detected, the processor 150 may command the speaker 135 to present an audible alert directing the passenger to check the location of the object as detected by the object detection sensor. The processor 150 may be programmed to unlock the doors after the delay period has ended, after the object is picked up, or at another time.

If an object is left behind or about to be left behind, the processor 150 may be programmed to attempt to contact the most recent passenger. The processor 150 may query the memory 145 for contact information of the most recent passenger. The processor 150 may command the communication interface 130 to contact the most recent passenger via a phone call, text message, email, or any other form of wireless communication. If the processor 150 determines that the object left behind is a cell phone or other mobile device, the processor 150 may command the communication interface 130 to send an alert to the mobile device. The passenger may hear the mobile device ring or vibrate so long as the passenger has not yet left the host vehicle 100 or gone too far away. This may include the processor 150 commanding the vehicle windows to at least partially roll down to make it more likely that the passenger hears the ringing or vibration of the mobile device.

Moreover, in some instances, if an object is left behind, the processor 150 may command the host vehicle 100 to stay parked or at least stay relatively near the location where the passenger was dropped off so that the passenger will have an opportunity to retrieve the object before the host vehicle 100 is too far away. The processor 150 may do so by outputting a command signal to the autonomous mode controller 155 instructing the autonomous mode controller 155 to stay parked, stay in the area, etc. If the host vehicle 100 is required to move, which may occur if the host vehicle 100 is blocking traffic or is subject to a regulation (e.g., no standing, no parking, etc.), the processor 150 may be programmed to command the autonomous mode controller 155 to “circle the block” to keep the host vehicle 100 near the passenger, at least until the passenger can retrieve the object left behind or until a predetermined amount of time expires. During this time, the processor 150 may command the host vehicle 100 to reject requests for ride sharing or autonomous taxi services. The processor 150 may be programmed to take other actions such as beeping the vehicle horn, flashing the vehicle headlights, etc., to try to get the passenger's attention before the passenger goes too far away.

The autonomous mode controller 155 is a microprocessor-based controller implemented via circuits, chips, or other electronic components. The autonomous mode controller 155 may be programmed to autonomously operate the host vehicle 100 in an autonomous or partially autonomous mode. That is, the autonomous mode controller 155 may be programmed to output signals to various actuators. The signals that control the actuators allow the autonomous mode controller 155 to control the steering, braking, and acceleration of the host vehicle 100. The autonomous mode controller 155 may control the actuators according to sensors located on the host vehicle 100. The sensors may include, e.g., lidar sensors, radar sensors, vision sensors (cameras), ultrasonic sensors, or the like. Each actuator is controlled by control signals output by the autonomous mode controller 155. Electrical control signals output by the autonomous mode controller 155 may be converted into mechanical motion by the actuator. Examples of actuators may include a linear actuator, a servo motor, or the like.

FIGS. 3A and 3B illustrate example interior views of the host vehicle 100 with the object detection system 105. FIG. 3A illustrates a cup holder 170, the object sensor 110, and one possible interior light 120. As shown in FIG. 3A, the object sensor 110 is located in or near the cup holder 170 so it can detect an object 190 in the cup holder 170. The interior light 120, which is incorporated into the rim of the cup holder 170, illuminates to, e.g., alert an occupant that an object 190 is in the cup holder 170. FIG. 3B shows a door handle 165 with the egress sensor 115 and the status light 125. When the egress sensor 115 detects than an occupant is reaching for the door handle 165 or attempts to open the door with the door handle 165, the status light 125 may illuminate, as discussed above, to indicate that an object 190 has been left behind in the host vehicle 100, that the vehicle doors are locked, that the vehicle doors will unlock when the object 190 is removed, that the passenger is permitted to exit the host vehicle 100, or the like. The operation of the interior light 120 and status light 125 of FIGS. 3A and 3B may be controlled by the processor 150, as discussed above.

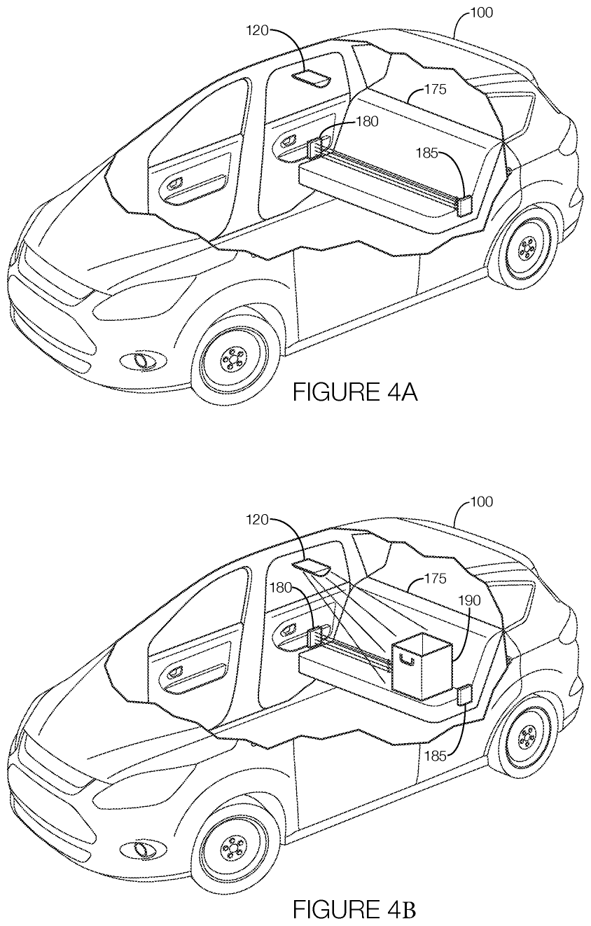

FIGS. 4A and 4B illustrate an example vehicle light that illuminates an area inside the host vehicle 100 to help the passenger find the potentially forgotten object 190. FIG. 4A illustrates a seat 175, the object sensor 110, and the interior light 120, shown as a dome light. The object sensor 110 is implemented as a light scanner with light transmitters 180 that transmit light the seat 175. The light is transmitted to corresponding receivers 185. The space between the transmitter 180 and receiver 185 is empty in FIG. 4A, meaning that no objects were left on the seat 175. When an object 190 is left behind, such as is shown in FIG. 4B, the object 190, shown as a grocery bag, prevents light from reaching the receiver 185. In that case, the object sensor 110 outputs the object detection signal indicating that an object 190 has been left behind, the location in the vehicle where the object 190 was detected, etc. The interior light 120 illuminates the object 190. The processor 150, as discussed above, may control the operation of the interior light 120 in accordance with the object detection signal output by the object sensor 110. Thus, not only does the interior light 120 illuminate, it directs light on to the object 190.

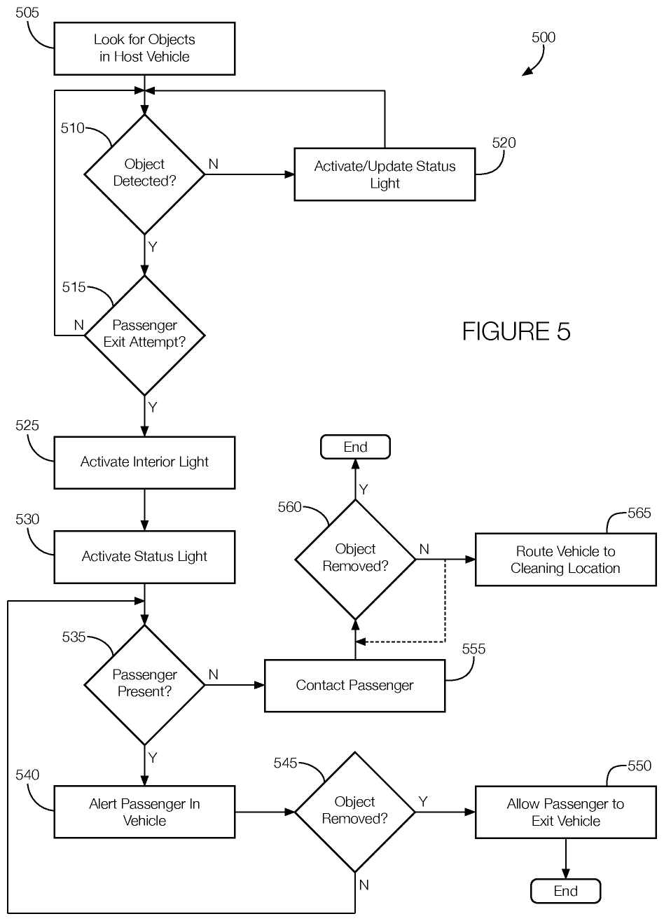

FIG. 5 is a flowchart of an example process 500 that may be executed by the object detection system 105 to detect the potentially forgotten object in the host vehicle 100 before the passenger has exited the host vehicle 100. The process 500 may begin at any time and may continue to execute so long as the host vehicle 100 is on and operating, including accepting new passengers and transporting passengers to various destinations. In some instances, the process 500 begins when the host vehicle 100 arrives at its destination with a passenger already inside the host vehicle 100.

At block 505, the object detection system 105 looks for objects in the host vehicle 100. For instance, the object sensor 110 may search for an object in the host vehicle 100. The object sensor 110 may begin searching for an object in the host vehicle 100 as soon as the object sensor 110 is powered, upon receipt of a control signal from the processor 150, or the like. The object sensor 110 is programmed to output the object detection signal, which may indicate that an object is present, to the processor 150, and the object detection signal.

At decision block 510, the object detection system 105 determines whether an object has been detected. That is, the processor 150 may monitor the output of the object sensor 110 and determine that an object has been detected when the object detection signal is received at the processor 150. In some instances, the processor 150 processes the object detection signal to determine if an object is present. When the object has been detected, the process 500 may proceed to block 515. Otherwise, the process 500 may proceed to block 520.

At decision block 515, the object detection system 105 determines whether the passenger is attempting to exit the host vehicle 100. That is, the egress sensor 115 may detect when the passenger is attempting to, e.g., open the vehicle door. The egress sensor 115 outputs the egress signal to the processor 150 when the egress sensor 115 determines that the passenger is attempting to open the vehicle door. In some instances, the processor 150 monitors and processes the egress signal to determine if the passenger is attempting to exit the host vehicle 100. If the processor 150 determines that the passenger is attempting to exit the host vehicle 100, the process 500 proceeds to block 525. Otherwise, the process 500 returns to block 510.

At block 520, the object detection system 105 activates the status light 125. The processor 150 may determine which status the status light 125 should present by querying the look-up table stored in the memory 145, and the result of the query may allow the processor 150 to determine which control signal to output to the status light 125. That is, continuing with the color-coded example above, the result of the query may allow the processor 150 to determine whether the status light 125 should shine red, yellow, or green. The processor 150 may output a control signal to make the status light 125 may shine green at block 520 since no objects have been identified in the host vehicle 100 and the passenger would be free to exit the host vehicle 100 at its destination. The process 500 may proceed back to block 510 after block 520.

At block 525, the object detection system 105 activates the interior light 120. The processor 150 may activate the interior light 120 by outputting an illumination signal to the interior light 120 associated with the object sensor 110 that detected the object. The processor 150 may select the interior light 120 by querying a look-up table, and the query may identify the object sensor 110. The processor 150 may output the illumination signal to the interior light 120 identified as a result of the query. Moreover, activating the interior light 120 may include the processor 150 commanding the interior light 120 to shine directly onto the object or onto an area near the object. For instance, if the object is determined to be located in the cup holder 170, the processor 150 may command the interior light 120 to shine on the cup holder 170.

At block 530, the object detection system 105 activates the status light 125. The processor 150 may determine which status the status light 125 should present by querying the look-up table stored in the memory 145, and the result of the query may allow the processor 150 to determine which control signal to output to the status light 125. That is, continuing with the color-coded example above, the result of the query may allow the processor 150 to determine whether the status light 125 should shine red, yellow, or green. The processor 150 may output a control signal at block 530 to make the status light 125 shine yellow when an object is detected in the host vehicle 100 but the passenger is permitted to open the vehicle door despite the potentially left-behind object. The processor 150 may output a control signal at block 530 to make the status light 125 shine red if the doors are locked and the passenger is prevented from opening the vehicle door because, e.g., exiting the host vehicle 100 will mean that an object will be left behind.

At decision block 535, the object detection system 105 determines whether the passenger is still present in the host vehicle 100. The processor 150 may determine whether the passenger is present based on a signal received from an occupant detection system. If the passenger is present, the process 500 may proceed to block 540. If the passenger has already exited the host vehicle 100, the process 500 may proceed to block 555.

At block 540, the object detection system 105 alerts the passenger of the left-behind object. Besides illuminating the interior light 120, the processor 150 may output signals to the speakers 135, the buzzer 140 in the door handle, etc., to alert the passenger that the object remains set down in the host vehicle 100. The processor 150 may further command the communication interface 130 to call or send a text message to the passenger's mobile device, which may cause the mobile device to ring or vibrate. An alert may also be sent via, e.g., Bluetooth® if the mobile device is still paired with the communication interface 130. The call or text message may include a notification that an object has been detected, the location of the object, or the like. The intensity of the notifications may escalate the longer the object remains left in the host vehicle 100.

At decision block 545, the object detection system 105 determines if the object was removed. For instance, the processor 150 continues to monitor the object detection signal to determine if the object is no longer present. If so, the process may proceed to block 550. Otherwise, the process 500 may return to block 535.

At block 550, the object detection system 105 allows the passenger to exit the host vehicle 100. That is, the processor 150 may output a signal to the body mode controller instructing the body mode controller to, e.g., unlock the vehicle doors.

At block 555, the object detection system 105 attempts to contact the passenger to return to the host vehicle 100 to retrieve the object. The processor 150 may command the communication interface 130 to call or text the passenger's mobile device. The call or text message may include a notification that the object was left behind. If the processor 150 determines that the object left behind was the passenger's mobile device, the processor 150 may command the communication interface 130 to call the mobile device while commanding the vehicle windows to at least partially roll down so that the passenger might hear the mobile device ring before he or she is too far away from the mobile device. In some instances, the processor 150 may command the autonomous mode controller 155 to keep the host vehicle 100 parked, or at least nearby, so the passenger can retrieve the object. In doing so, the processor 150 may command the autonomous mode controller 155 to reject future ride requests, to circle the block, or both. The processor 150 may take other actions such as beeping the vehicle horn, flashing the vehicle headlights, etc., to try to get the passenger's attention. The intensity of the notifications may escalate the longer the object remains left in the host vehicle 100.

At decision block 560, the object detection system 105 determines if the object was removed. For instance, the processor 150 continues to monitor the object detection signal to determine if the object is no longer present. If so, the process may end. Otherwise, the process 500 may continue to execute block 560 while continuing to output alerts for the passenger to remove the object for some period of time (e.g., on the order of a few minutes). Eventually, the process 500 may proceed to block 565 if the object is not removed. In some possible approaches, the process 500 may end even if an object was detected but not removed. For instance, if the object is small and not likely to affect a subsequent passenger's experience, the process 500 may end. For instance, the process 500 may end, and the host vehicle 100 may remain in service, even though, e.g., a small candy wrapper was left in the cup holder.

At block 565, the object detection system 105 routes the host vehicle 100 to a cleaning location. The processor 150 may, after a predetermined amount of time has elapsed, command the autonomous mode controller 155 to proceed to the cleaning location so, e.g., the object can be removed. From the cleaning location, the host vehicle 100 may resume its ride sharing or autonomous taxi service. The process 500 may end after block 565.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A vehicle system comprising:
a memory; and
a processor programmed to execute instructions stored in the memory, the instructions including receiving an object detection signal and an egress signal, determining that the object detection signal represents an object in a host vehicle, determining that the egress signal represents a passenger attempting to exit the host vehicle, and activating an interior light in accordance with the object detection signal and the egress signal.

2. The vehicle system of claim 1, wherein the processor is programmed to activate the interior light by outputting an illumination signal to the interior light.

3. The vehicle system of claim 1, wherein the interior light is one of a plurality of interior lights and wherein the processor is programmed to select at least one of the plurality of interior lights to activate.

4. The vehicle system of claim 3, wherein the processor is programmed to select among the plurality of interior lights by querying a look-up table stored in the memory, wherein the query identifies an object sensor that output the object detection signal.

5. The vehicle system of claim 3, wherein the processor is programmed to select among the plurality of interior lights by querying a look-up table stored in the memory, wherein the query identifies a location of an object sensor that output the object detection signal.

6. The vehicle system of claim 1, wherein the processor is programmed to control a status light according to the object detection signal and the egress signal.

7. The vehicle system of claim 1, wherein the processor is programmed to monitor an output of an object sensor to determine whether the object detection signal represents the object in the host vehicle.

8. The vehicle system of claim 1, wherein the processor is programmed to monitor an output of an egress sensor to determine whether the egress signal indicates that the passenger is attempting to exit the host vehicle.

9. The vehicle system of claim 1, wherein the processor is programmed to command the interior light to shine on the object in accordance with the object detection signal and the egress signal.

10. The vehicle system of claim 1, wherein the processor is programmed to command the interior light to shine on an area near the object in accordance with the object detection signal and the egress signal.

11. A method comprising:
receiving an object detection signal;
receiving an egress signal;
determining that the object detection signal represents an object in a host vehicle;
determining that the egress signal represents a passenger attempting to exit the host vehicle; and
activating an interior light in accordance with the object detection signal and the egress signal.

12. The method of claim 11, wherein activating the interior light includes outputting an illumination signal to the interior light.

13. The method of claim 11, wherein the interior light is one of a plurality of interior lights, and the method further comprising selecting at least one of the plurality of interior lights to activate.

14. The method of claim 13, wherein selecting among the plurality of interior lights includes querying a look-up table stored in a memory, wherein the query identifies an object sensor that output the object detection signal.

15. The method of claim 13, wherein selecting among the plurality of interior lights includes querying a look-up table stored in a memory, wherein the query identifies a location of an object sensor that output the object detection signal.

16. The method of claim 11, further comprising controlling a status light according to the object detection signal and the egress signal.

17. The method of claim 11, further comprising monitoring an output of an object sensor to determine whether the object detection signal represents the object in the host vehicle.

18. The method of claim 11, further comprising monitoring an output of an egress sensor to determine whether the egress signal indicates that the passenger is attempting to exit the host vehicle.

19. The method of claim 11, further comprising commanding the interior light to shine on the object in accordance with the object detection signal and the egress signal.

20. The method of claim 11, further comprising commanding the interior light to shine on an area near the object in accordance with the object detection signal and the egress signal.
